(19) United States
(12) Patent Application Publication
(10) Pub. No.: US 2015/0247563 A1
(43) Pub. Date: Sep. 3, 2015

(54) HIGH TORQUE POWER MODULE

(71) Applicant: Harmonic Innovation Technology Co., Ltd., Taipei City (TW)

(72) Inventor: Chun-Shen YEH, Taipei City (TW)

(21) Appl. No.: 14/477,193

(22) Filed: Sep. 4, 2014

(30) Foreign Application Priority Data
Mar. 3, 2014 (TW) 103107072

(51) Int. Cl. F16H 49/00

(52) U.S. Cl. CPC F16H 49/001; F16H 2049/003

(57) ABSTRACT

The invention provides a high torque power module comprised a power unit and a reduction unit. The power unit outputs a first horsepower with a first rotating speed and a first torque. The reduction unit decreases the first rotating speed to a second rotating speed, and the first torque is increased to a second torque. The reduction unit outputs a second horsepower. The present invention converts a power with high rotating speed and low torque to a power with low rotating speed and high torque by the reduction unit. The high torque power module has the advantages of low rotating speed, high torque, small size, and low cost.

### CROSS-REFERENCE TO RELATED APPLICATIONS

This Non-provisional application claims priority under 35 U.S.C. §119(a) on Patent Application No(s). 103107072 filed in Taiwan, Republic of China Mar. 3, 2014, the entire contents of which are hereby incorporated by reference.

### FIELD OF THE INVENTION

The invention is related to the power transmission field, especially where high torque and low rotating speed, low cost and durability are required, and precision is not so crucial.

### BACKGROUND OF THE INVENTION

Traditionally, a high-speed power device, such as an electric motor, an internal combustion engine or a motor, is used in the transmission device with low rotating speed and high torque. The high-speed power device typically converts a power source with high rotating speed and low torque into a power source with low rotating speed and high torque via a reducer. The traditional reducers include a gear reducer, a worm wheel reducer, a planetary reducer, a harmonic drive and so on.

However, the small size reducers, such as the gear reducer, the worm wheel reducer, and the planetary reducer, can only provide low reduction ratio. Therefore, in order to obtain a high reduction ratio, the reducer may become a complex structure in large size where more components are involved.

In order to solve the above-mentioned problems, a harmonic drive with small size, light weight, high precision and less components has been developed. However, such harmonic drive has the disadvantages of high cost and short durability.

In order to resolve these disadvantages of the conventional techniques, the present invention presents a high torque power module which is low cost and durable.

### SUMMARY OF THE INVENTION

The first purpose of the present invention is to present a high torque power module. The power module comprises a reduction unit with a high reduction ratio which can convert a high rotating speed and a low torque of a motor power into a low rotating speed and a high torque of a motor power. As such, the power module has the advantages of low rotating speed, high torque, small size, light weight and low cost.

The second purpose of the present invention is to produce a transmission mechanism, which could include a single or multiple power sources, does not demand high precision—such as an electric car, an electric bicycle or an electric rolling door.

The third purpose of the present invention is to produce high reduction ratio by adjusting the number of teeth in a circular gear with external teeth and the number of teeth in a ring gear with internal teeth.

In order to achieve the above-mentioned purposes, the present invention presents a high torque power module which comprises a power unit and a reduction unit. The power unit provides a first rotating speed and a first torque. The power unit outputs a first horsepower which is the product of the first rotating speed and the first torque. The reduction unit is coupled with the power unit. The reduction unit decreases the first rotating speed to a second rotating speed, increases the first torque up to the second torque; therefore, outputs a second horsepower which is the product of the second rotating speed and the second torque.

Compared to conventional technology, the high torque power module of this invention can convert a motor power with high rotating speed and low torque into a motor power with low rotating speed and high torque. This power module does not particularly provide high precision, but provides small size, light weight, low cost and durability of the transmission mechanism.

### BRIEF DESCRIPTION OF THE DRAWINGS

FIG. 1 shows an exploded view of the high torque power module in the invention.

### DETAILED DESCRIPTION OF THE INVENTION

For clarity of disclosure, the detailed description of the invention follows:

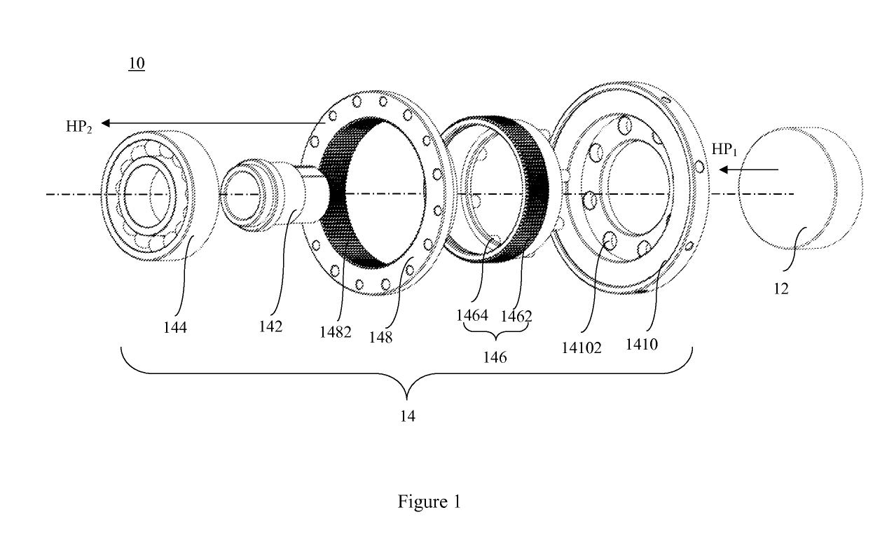

The FIG. 1 shows an exploded view of the high torque power module in the present invention. As shown in FIG. 1, the high torque power module 10 comprises a power unit 12 and a reduction unit 14.

The power unit 12 is a power source providing a first rotating speed (high rotating speed) and a first torque (low torque). The power unit 12 is an electric device, such as a motor. The power unit 12 outputs a first horsepower HP₁. The definition of the first horsepower HP₁ is the product of the first rotating speed and the first torque.

The reduction unit 14 is coupled with the power unit 12 to receive first horsepower HP₁ from the power unit 12. The reduction unit 14 decreases the first rotating speed to a second rotating speed and increases the first torque to the second torque. The reduction unit 14 outputs a second horsepower HP₂.

In detail, the reduction unit 14 comprises an eccentric shaft 142, a bearing 144, a circular gear with external teeth 146, a ring gear with internal teeth 148 and a constraint plate 1410. The eccentric shaft 142 is combined with the bearing 144 to pass through the circular gear with external teeth 146. The circular gear with external teeth 146 is connected to the constraint plate 1410 and partially engaged with the ring gear with internal teeth 148.

The center axis of the eccentric shaft 142 is coaxial with the center axis of the reduction unit 14, and the wall thickness of the eccentric shaft 142 is asymmetric.

The circular gear with external teeth 146 includes multiple first gear teeth 1462 on the outer side, and the number of the first gear teeth 1462 is the first number T 1. The circular gear with external teeth 146 is partially engaged with the ring gear with internal teeth 148. A plurality of constraint columns 1464 are disposed on the circular gear with external teeth 146 to connect to the constraint plate 1410.

The ring gear with internal teeth 148 includes multiple second gear teeth 1482 on the inner side, and the number of the second gear teeth 1482 is the second number T2.

The constraint plate 1410 includes multiple round holes 14102. The diameters of the round holes 14102 are larger than the diameters of the constraint columns 1464.

The action principle of the reduction unit 14: when the eccentric shaft 142 rotates, the eccentric shaft 142 drives the circular gear with external teeth 146 via the bearing 144. Because the wall thickness of the eccentric shaft 142 is asymmetric, when the circular gear with external teeth 146 rotates, the axis of the circular gear with external teeth 146 is not fixed in the center. Moreover, the circular gear with external teeth 146 does not rotate with the eccentric shaft 142 meaning that the circular gear with external teeth 146 does not rotate with its own axis. The circular gear with external teeth 146 is constrained to slight movement in the round holes 14102 with the constraint columns 1464. During this movement, a portion of the first gear teeth 1462 of the circular gear with external teeth 146 is continuously engaged with a portion of the second gear teeth 1482 of the ring gear with internal teeth 148. The first number T1 of the first gear teeth 1462 is different from the second number T2 of the second gear teeth 1482, that resulting the ring gear with internal teeth 148 rotate slowly.

The definition of reduction ratio RR of the reduction unit 14 is the ratio of the second number T2 to a teeth difference D. The teeth difference D is the difference between the first number T1 and the second number T2. As a result, the mathematic expression of the reduction ratio RR follows:

RR=T2/D

It should be noted that the reduction ratio RR of the reduction unit 14 of the invention is much larger than the reduction ratio of conventional planetary reducers.

For example, the first rotating speed of the power unit 12 is 3000 rpm (revolution per minute), the first torque of the power unit 12 is 1 Nm (Newton-meter), and the reduction ratio RR of the reduction unit 14 is 30. When the power unit 12 is connected to the reduction unit 14, the reduction unit 14 outputs a rotating speed of 100 rpm and a torque of 30 Nm. Compared with the original motor power of the power unit 12, the power output decreases to 100 rpm (low rotating speed) from 3000 rpm (high rotating speed), and the torque increases to 30 Nm (high torque) from 1 Nm (low torque).

In application, the high torque power module 10 can be applied to an electric bicycle with a transmission gear module. The transmission gear module is connected to the high torque power module 10. When the electric bicycle starts up, the power unit 12 (a motor) of the high torque power module 10 outputs a power with high rotating speed and low torque. The reduction unit 14 then decreases the rotating speed and increases the torque. Moreover, this application of the invention on electric bicycle has many advantages. For example, (1) because the size of the high torque power module 10 is small, it lighten the electric bicycle. (2) Because the reduction unit 14 is durable, the life time of the high torque power module 10 won't be limited by the reduction unit 14. (3) Because the electric bicycle utilizes power with high rotating speed and low torque, compared with the conventional motor power with low rotating speed and high torque, the present invention has the advantage of lower cost.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

What is claimed is:

1. A high torque power module, comprising:
a power unit, providing a first rotating speed and a first torque, the power unit outputs a first horsepower which is a product of the first rotating speed and the first torque; and
a reduction unit, coupled with the power unit, the reduction unit decreases the first rotating speed to a second rotating speed, and increases the first torque to a second torque, and outputs a second horsepower which is a product of the second rotating speed and the second torque.

2. The high torque power module according to claim 1, wherein the reduction unit comprises an eccentric shaft, a bearing, a circular gear with external teeth, a ring gear with internal teeth and a constraint plate; the eccentric shaft is combined with the bearing to pass through the circular gear with external teeth connected to the constraint plate and partially engaged with the ring gear with internal teeth.

3. The high torque power module according to claim 2, wherein the circular gear with external teeth has a first number of gear teeth and the ring gear with internal teeth has a second number of gear teeth, a teeth difference exists between the first number and the second number; and the ratio of the second number to the teeth difference is a reduction ratio.
